(19) United States
(12) Patent Application Publication
(10) Pub. No.: US 2010/0118460 A1
(43) Pub. Date: May 13, 2010

(54) DC drive

(75) Inventors: Jian-Shen Li, Hsinchu (TW); Cheng-Chih Chu, Hsinchu (TW); Chun-Liang Lin, Hsinchu (TW)

Correspondence Address: Jian-Shen Li, P.O. Box 44-2049, Taipei, 10668, TW

(73) Assignee: Grenergy Opto, Inc.

(21) Appl. No.: 12/289,988

(22) Filed: Nov. 10, 2008

(51) Int. Cl. H02H 3/00; G05F 5/00

(52) U.S. Cl. 361/84; 323/299

(57) ABSTRACT

A direct current (DC) drive includes a voltage input unit, a comparing unit, a latch unit and a voltage output unit. The voltage input unit has at least one input terminal and at least one output terminal provides a DC voltage. The comparing unit receives the DC voltage and generates a comparison control signal according to a comparison result obtained by comparing a voltage of a positive voltage terminal with a voltage of a negative voltage terminal. The latch unit is connected to the comparing unit and the voltage input unit. The voltage output unit connected to the latch unit receives the DC voltage from the voltage input unit. The latch unit selectively provides the DC voltage to the voltage output unit according to the comparison control signal.

### BACKGROUND OF THE INVENTION

(1) Field of the Invention

The invention relates to a direct current (DC) drive, and more particularly to use a rectifier to enable an input voltage of a voltage input terminal not only drives an external electronic device but also provides a desired DC for DC drive.

(2) Description of the Prior Art

Conventionally, if positive and negative circuits have to be simultaneously used, two different voltage source paths are needed. In addition, the two different voltage source paths are not used effectively and directly to internal circuit.

For example, when a DC motor is controlled to rotate clockwise or counterclockwise, two symmetrical circuits are often used to control the motor. However, the internal circuit for controlling the DC motor often needs the power source so that the manufacturing cost is increased and the stability thereof is influenced. More particularly, after the integrated circuit is manufactured, the decrease of the extra voltage source inputs has become the most important consideration for enhancing the stability and decreasing the cost.

In view of these, a DC drive is needed to solve the conventional drawbacks.

### SUMMARY OF THE INVENTION

The invention provides a DC drive for respectively providing desired voltages for the DC drive according to different input voltages.

The invention further provides a protecting device for DC drive to control a latch unit to latch a voltage output unit according to a comparison control signal generated via a comparing unit.

In one embodiment, a DC drive is provided. The DC drive includes a voltage input unit, a comparing unit, a latch unit and a voltage output unit. The voltage input unit for providing a DC voltage has at least one input terminal and at least one output terminal. The comparing unit receives the DC voltage and generates a comparison control signal according to a comparison result obtained by comparing a voltage of a positive voltage terminal with a voltage of a negative voltage terminal. The latch unit is connected to the comparing unit and the voltage input unit. The voltage output unit is connected to the latch unit and receives the DC voltage from the voltage input unit. The latch unit selectively provides the DC voltage to the voltage output unit according to the comparison control signal.

In another embodiment, a protecting device for DC drive applied to an electronic device is provided. The DC drive protecting device includes a voltage input unit, a comparing unit, a latch unit, a voltage output unit and a protecting circuit. The voltage input unit for providing a DC voltage has at least one input terminal and at least one output terminal. The comparing unit receives the DC voltage and generates a comparison control signal according to a comparison result obtained by comparing a voltage of a positive voltage terminal with a voltage of a negative voltage terminal. The latch unit is connected to the comparing unit and the voltage input unit. The voltage output unit is connected to the latch unit and receives the DC voltage from the voltage input unit. The protecting circuit is coupled to the voltage output unit and the electronic device to prevent a reverse voltage. The latch unit selectively provides the DC voltage to the voltage output unit according to the comparison control signal.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a block diagram showing a DC drive of the invention.

FIG. 2a shows a structure of a rectifier unit of FIG. 1.

FIG. 2b shows another structure of the rectifier unit of FIG. 2a.

FIG. 2c shows still another structure of the rectifier unit of FIG. 1.

FIG. 3 is a schematic circuit diagram showing the DC drive of the invention.

### DETAILED DESCRIPTION OF THE PREFERRED EMBODIMENTS

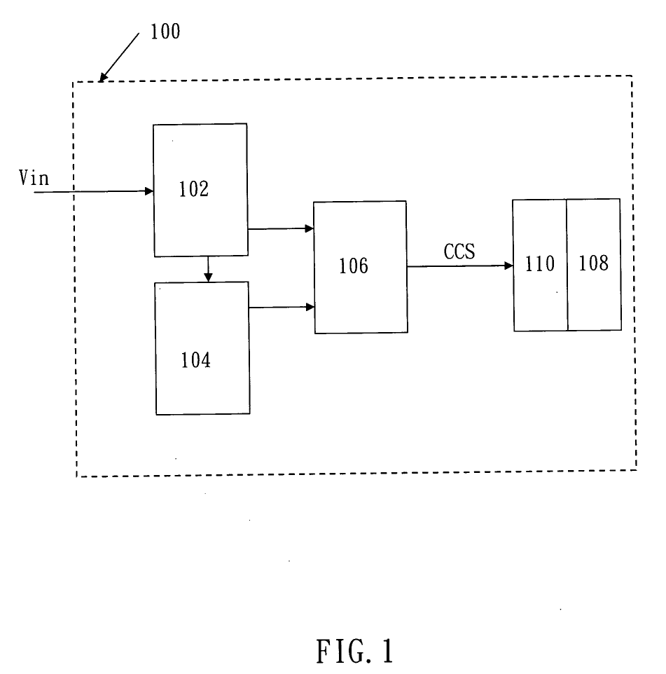

The invention discloses a DC drive, wherein a rectifier is used at a voltage input unit so that the DC drive uses the same input voltage, and a latch unit is used to latch a voltage output unit. In order to describe the invention in detail, illustrations will be made with reference to FIGS. 1 to 3.

FIG. 1 is a block diagram showing a DC drive of the invention. In this embodiment, a DC drive 100 is provided. The DC drive 100 includes a voltage input unit 102, a comparing unit 104, a latch unit 106 and a voltage output unit 108. The voltage input unit 102 has at least one output terminal for providing a DC voltage Vin. The comparing unit 104 receives the DC voltage Vin, and generates a comparison control signal CCS (to be described herein below) according to a comparison result obtained by comparing a voltage of a positive voltage terminal with a voltage of a negative voltage terminal. The latch unit 106 is connected to the comparing unit 104 and the voltage input unit 102. The voltage output unit 108 is connected to the latch unit 106, and receives the DC voltage Vin from the voltage input unit 102. The latch unit 106 selectively provides the DC voltage Vin to the voltage output unit 108 according to the comparison control signal CCS.

In addition, the DC drive 100 further includes a protecting circuit 110, coupled to the voltage output unit 108, for preventing a reverse voltage. For example, the DC drive 100 generates a reverse discharge voltage after the voltage output unit 108 output, the reverse voltage has a discharge path through the protecting circuit 110, and doesn't feed back to the DC drive 100 so that the protection effect can be achieved.

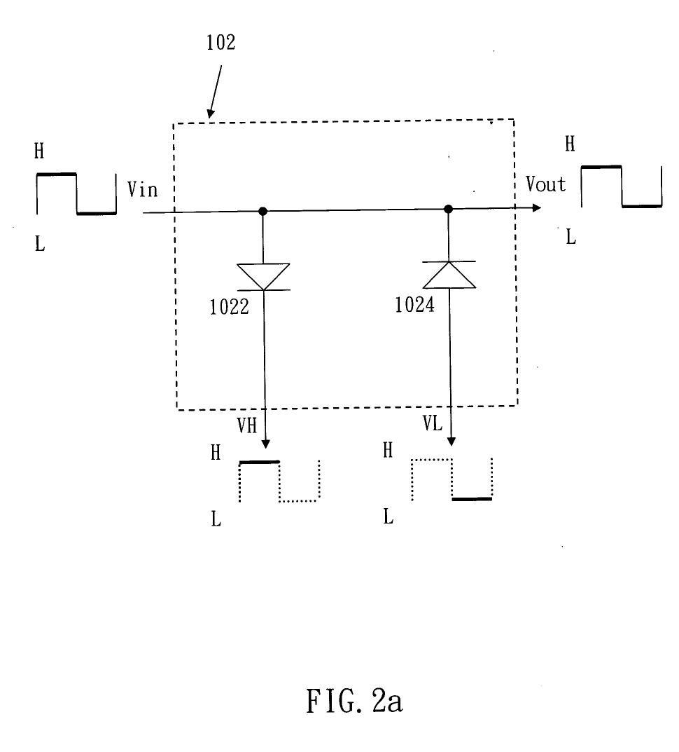

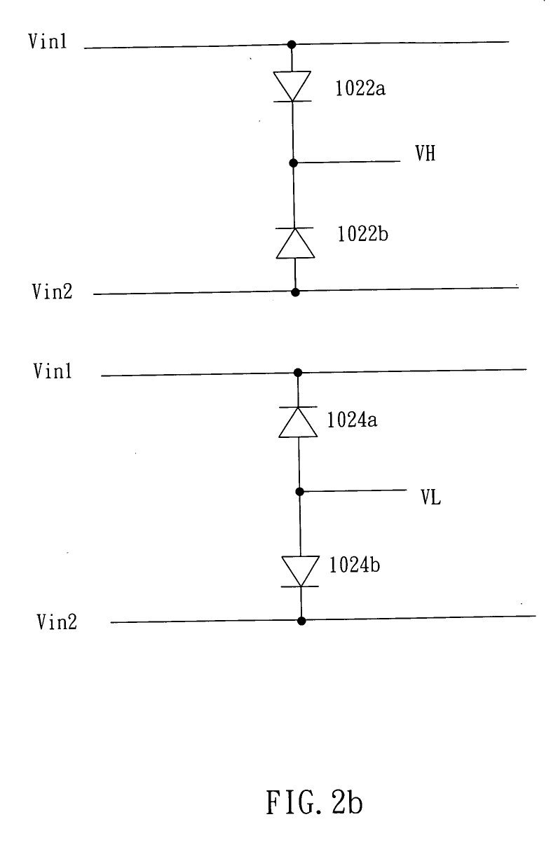

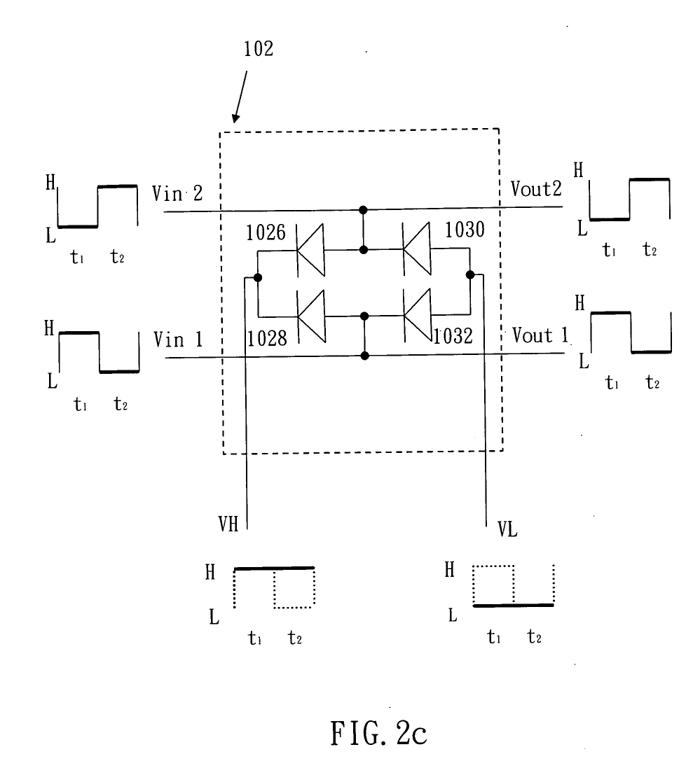

Perfectly, FIG. 2a shows a structure of a rectifier unit of FIG. 1. As shown in FIG. 2a, the voltage input unit 102 includes a rectifier unit composed of at least one diode. In this embodiment, the diodes 1022, 1024 are constituted of the rectifier unit. When the DC voltage Vin is at the high level H, the diode 1022 turns on and provides the high level H to the n terminal of the diode 1022. On the contrary, when the DC voltage Vin is at the low level L, the diode 1024 turns on and provides the low level L to the p terminal of the diode 1024. More particularly, the diodes 1022, 1024 are connected to the comparing unit 104 of FIG. 1 to provide the driving voltage required by the comparing unit 104. Thus, the DC voltage Vin can be directly provided to the DC drive 100. In addition, a voltage Vout at the output terminal of the voltage input unit 102 is equal to the voltage Vin at the input terminal of the voltage input unit 102.

FIG. 2b shows another structure of the rectifier unit of FIG. 2a. In this embodiment, as shown in FIG. 2b, the voltage input unit 102 has two voltage input terminals Vin1 and Vin2, which simultaneously or respectively input a high level voltage or a low level voltage. As shown in the drawing, when the input voltages at the voltage input terminals Vin1 and Vin2 are the high level voltages, the output voltage at the VH terminal is the high level voltage. That is, the diodes 1022a, 1022b allow the high level voltage to pass through and reach the VH terminal. When the input voltages of the voltage input terminals Vin1 and Vin2 are the low level voltages, the input voltages cannot reach the VH terminal through the diodes 1022a and 1022b. On the contrary, the following drawing shows the state wherein the diodes 1024a, 1024b allow the low level voltages to pass through. That is, when the input voltages at the voltage input terminals Vin1 and/or Vin2 are the low level voltages, the input voltages reach the VL terminal through the diodes 1024a, 1024b.

FIG. 2c shows still another structure of the rectifier unit of FIG. 1. In another embodiment, as shown in FIG. 2c, the voltage input unit 102 may further be a bridge rectifier unit having at least one bridge voltage input unit and at least one bridge voltage output unit. In this embodiment, the bridge rectifier unit is composed of four diodes 1026, 1028, 1030, and 1032. The DC voltages Vin1 and Vin2 with different levels are inputted. The DC voltage Vin1 turns on the diode 1028 so that the high level VH is provided within the period t1, and the diode 1032 is in the off state. On the contrary, The DC voltage Vin2 turns on the diode 1030 so that the low level VL is provided within the period t2, and the diode 1026 is in the off state. That is, in the same time, the bridge rectifier unit of the invention can be utilized to turn on the diodes 1028 and 1030 within the period t1, or to turn on the diodes 1026, 1032 within the period t2. Meanwhile, the driving voltage required by the comparing unit 104 is provided. For example, the comparing unit 104 may be an operational amplifier (OPA), which may be driven by the driving voltage (the high level VH and the low level VL) provided by the voltage input unit 102. In addition, the voltages Vout1, Vout2 at the output terminals of the voltage input unit 102 are equal to the voltages Vin1, Vin2 at the input terminals.

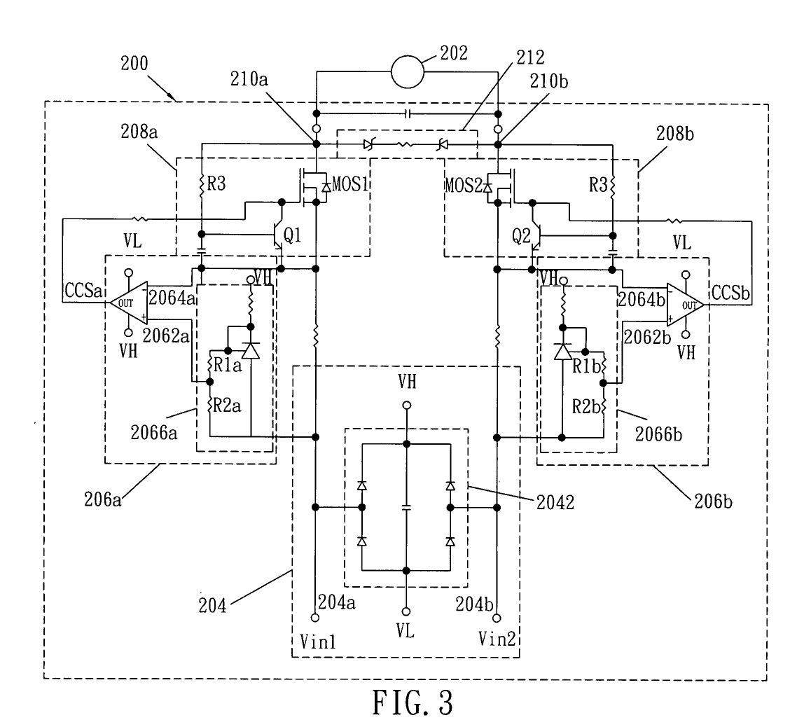

FIG. 3 is a schematic circuit diagram showing the DC drive of the invention. In this embodiment, a DC drive protecting device 200 applied to an electronic device 202, such as a DC motor, is provided. The protecting device for DC drive 200 includes a voltage input unit 204, symmetrical comparing units 206a, 206b, symmetrical latch units 208a, 208b, voltage output terminals 210a, 210b and a protecting circuit 212. The voltage input unit 204 has voltage input terminals 204a, 204b and is for providing the DC voltages Vin1, Vin2, for example, having different levels voltages. The comparing units 206a, 206b respectively receive the DC voltages Vin1, Vin2, and generate comparison control signals CCSa and CCSb according to a comparison result obtained by comparing the voltage of a positive voltage terminal 2062a (or 2062b) with the voltage of a negative voltage terminal 2064a (or 2064b). For example, the comparing units 206a, 206b are composed of operational amplifiers (OPAs), are driven by the voltages VH and VL provided from the outside, and have a positive and a negative voltage input terminals and an output terminal. The latch unit 208a (or 208b) is connected to the comparing units 206a, 206b and the voltage input unit 204. The voltage input unit 204 is connected to the latch unit 208a (or 208b), and receives the DC voltages Vin1 and Vin2 from the voltage input unit 204. The protecting circuit 212 is coupled to the voltage output terminals 210a, 210b and the electronic device 202 to prevent the reverse voltage. The latch units 208a and 208b selectively provide the DC voltages Vin1 and Vin2 to the voltage output terminals 210a and 210b according to the comparison control signals CCSa and CCSb.

The operations of the voltage input unit 204, the symmetrical comparing units 206a and 206b, the symmetrical latch units 208a, 208b, the voltage output terminals 210a, 210b and the protecting circuit 212 are the same as those of the above-mentioned embodiment. In addition, the comparing units 206a, 206b further respectively include a reference voltage generating units 2066a, 2066b, which are respectively connected to the positive voltage terminal 2062a (or 2062b) and the negative voltage terminal 2064a (or 2064b) of the comparing units 206a and 206b. The reference voltage generating units 2066a and 2066b are connected to the resistors R1a (or R1b) and R2a (or R2b), and provide as a divided voltage to the positive voltage terminal 2062a (or 2062b) to form a reference voltage circuit. More particularly, the latch units 208a and 208b control the voltage outputs through the comparing units 206a and 206b when the current I exceeds a predetermined current. In this embodiment, for example, the latch unit is composed of a bipolar junction transistor (BJT) Q1 (or Q2) and/or a metal-oxide-semiconductor field-effect transistor (MOSFET) MOS1 (or MOS2). When the comparison result shows that the voltage of the negative voltage terminal 2064a (or 2064b) is higher than that of the positive voltage terminal 2062a (or 2062b), the MOSFET MOS1 (or MOS2) reaches a saturation mode. At this time, the voltage Vds between the drain and the source of the MOSFET MOS1 (or MOS2) is increased so that a biasing voltage is formed after the voltage Vds is fed back to the base of the transistor Q1 (or Q2) through the resistor R3. Thus, the transistor Q1 (or Q2) is turned on to turn off the MOSFET MOS1 (or MOS2) so that the object of latching can be achieved.

Furthermore, the voltage input unit 204 has the voltage input terminals 204a, 204b connected to the rectification circuit 2042, and provides the voltage required by the DC drive protecting device according to the levels of the DC voltages Vin1, Vin2, respectively. For example, the rectification circuit 2042 may be composed of at least one diode. The rectification circuit provides the DC voltages Vin1, Vin2 of the voltage input unit 204 to the comparing units 206a, 206b or provides one of the DC voltages Vin1, Vin2 of the voltage input unit 204 to the comparing units 206a, 206b (not shown in the drawing).

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A direct current (DC) drive, comprising:
a voltage input unit having at least one input terminal and at least one output terminal for providing a DC voltage;
a comparing unit receiving the DC voltage, and generating a comparison control signal according to a comparison result obtained by comparing a voltage of a positive voltage terminal with a voltage of a negative voltage terminal;
a latch unit connected to the comparing unit and the voltage input unit; and
a voltage output unit connected to the latch unit, and receives the DC voltage from the voltage input unit,
wherein the latch unit selectively provides the DC voltage to the voltage output unit according to the comparison control signal.

2. The DC drive according to claim 1, further comprises a protecting circuit coupled to the voltage output unit to prevent a reverse voltage.

3. The DC drive according to claim 2, wherein the voltage input unit further comprises a bridge rectifier unit having at least one bridge voltage input unit and at least one bridge voltage output unit.

4. The DC drive according to claim 3, wherein at least one diode is disposed between the bridge voltage input unit and the bridge voltage output unit.

5. The DC drive according to claim 3, wherein the bridge voltage output unit is connected to the comparing unit to drive the comparing unit.

6. The DC drive according to claim 1, wherein the comparing unit is composed of an operational amplifier (OPA) and at least one resistor.

7. The DC drive according to claim 1, wherein the latch unit is composed of a bipolar junction transistor (BJT) and/or a metal-oxide-semiconductor field-effect transistor (MOSFET).

8. The DC drive according to claim 7, wherein a drain of the MOSFET provides a driving voltage to a base of the bipolar junction transistor.

9. The DC drive according to claim 7, wherein a gate of the MOSFET receives the comparison control signal.

10. A protecting device for a direct current (DC) drive applied to an electronic device, the protecting device comprising:
a voltage input unit having at least one input terminal and at least one output terminal for providing a DC voltage;
a comparing unit for receiving the DC voltage, and generating a comparison control signal according to a comparison result obtained by comparing a voltage of a positive voltage terminal with a voltage of a negative voltage terminal;
a latch unit connected to the comparing unit and the voltage input unit;
a voltage output unit connected to the latch unit, and receives the DC voltage from the voltage input unit; and
a protecting circuit coupled to the voltage output unit and the electronic device to prevent a reverse voltage,
wherein the latch unit selectively provides the DC voltage to the voltage output unit according to the comparison control signal.

11. The protecting device according to claim 10, wherein the voltage input unit further comprises a rectifier unit, which has at least one rectifying voltage input unit and at least one rectifying voltage output unit.

12. The protecting device according to claim 11, wherein the rectifier unit is a bridge rectifier circuit composed of at least one diode.

13. The protecting device according to claim 12, wherein the bridge rectifier circuit provides the DC voltage of the voltage input unit to the comparing unit.

14. The protecting device according to claim 12, wherein the bridge rectifier circuit provides the DC voltages of the voltage input unit to the comparing unit.

15. The protecting device according to claim 10, wherein the comparing unit further comprises a reference voltage generating unit connected to the positive voltage terminal or the negative voltage terminal of the comparing unit.

16. The protecting device according to claim 10, wherein the latch unit is composed of a bipolar junction transistor and/or a metal-oxide-semiconductor field-effect transistor (MOSFET).

17. The protecting device according to claim 16, wherein a drain of the MOSFET provides a driving voltage to a base of the bipolar junction transistor.

18. The protecting device according to claim 17, wherein a gate of the MOSFET receives the comparison control signal.
